(19) United States
(12) Patent Application Publication
(10) Pub. No.: US 2010/0045996 A1
(43) Pub. Date: Feb. 25, 2010

(54) SENSING APPARATUS

(75) Inventors: Kentaro Furusawa, Tokyo (JP); Natsuhiko Mizutani, Tokyo (JP); Ryo Kuroda, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/528,491

(22) PCT Filed: Mar. 17, 2008
(86) PCT No.: PCT/JP2008/055609

§ 371 Date: Aug. 25, 2009

(30) Foreign Application Priority Data
Mar. 23, 2007 (JP) 2007-077892

(51) Int. Cl. G01N 21/55

(52) U.S. Cl. 356/445

(57) ABSTRACT

A sensing apparatus comprises a sensing element having a metal member of a periodic structure formed on a substrate, a light source for projecting a light beam to the sensing element, and a photosensor for sensing the light beam from the sensing element, wherein the sensing element has an optical waveguide layer between the substrate and the metal member, and the light beam illuminated from the light source and propagating in the optical waveguide layer and the light of a Rayleigh mode formed by the metal member are phase-matched.

### TECHNICAL FIELD

The present invention relates to a sensing apparatus employing a periodic metal structure which is useful for monitoring a dielectric response to an environmental change or monitoring a surface state such as an antigen-antibody reaction on a surface.

### BACKGROUND ART

A sensor based on surface plasmon resonance (SPR) utilizes surface plasmon polaritons (SPPs) induced at the interface between a metal and a dielectric material.

The SPPs induced at a flat interface has an electric field distribution in a space of several hundreds of nanometers on the surface. Therefore, it is useful as a sensor for a refractive index change near the surface. Generally, for inducing the SPPs, the phase of a illuminated light beam should be matched with the phase of the SPPs. For the phase-matching, an oblique light-introducing system with a prism is employed in a Kretchmann arrangement or like apparatuses. On the other hand, as well known, in place of the flat surface of the metal, a periodic fine structure of a metal is employed at the interface to match the phase of the introduced light beam with the phase of the SPPs.

This is exemplified by an SPR apparatus employing a one-dimensional grating system (Japanese Patent Application Laid-Open No. 2005-257458), and a two-dimensional system disclosed in Japanese Patent Application Laid-Open 2005-016963.

Such elements having a periodic metal structure are promising for improving the sensitivity of the plasmon-based sensors, since the incident angle conditions are less strict and precision for the geometric optic factor is less strict in comparison with conventional SPR on a flat face and various types of plasmon can be utilized.

The surface plasmon resonance is sensitive to a change of the refractive index on the metal surface. Generally a plasmon sensor detects a change of the resonance profile on the surface. Therefore, for the response to a certain perturbation, the steeper the resonance profile, the more sensitive is the sensor in principle.

Actually, however, the effective refractive index of the SPPs has a large imaginary part, which broadens the resonance profile. This limits the maximum sensitivity of the plasmon sensor. In particular, in the sensor having a periodic structure of a two-dimensional profile, the localization of plasmon at the interface causes further broadening of the profile disadvantageously.

On the other hand, a conventional plasmon sensor is capable of sensing within a short distance range, and is suitable for monitoring an adsorption reaction on a surface. This sensing distance range depends generally only on the electric field distribution at the interface. Since the surface electric field attenuates exponentially in the direction perpendicular to the surface, the sensitivity is localized at the surface characteristically. However, the high sensing sensitivity range cannot readily be provided at a desired position: for example, at around 20 nm above the surface in multiple layer adsorption of molecules.

### DISCLOSURE OF THE INVENTION

The present invention is directed to a sensing apparatus comprising a sensing element having a metal member of a periodic structure formed on a substrate, a light source for projecting a light beam to the sensing element, and a photosensor for sensing the light beam from the sensing element, wherein the sensing element has an optical waveguide layer between the substrate and the metal member, and the light beam illuminated from the light source and propagating in the optical waveguide layer and the light of a Rayleigh mode formed by the metal member are phase-matched.

The waveguide layer can be in a single mode.

The light of the Rayleigh mode can be a primary diffracted wave of the light illuminated from the light source.

The surface plasmon polariton induced by the periodic structure can satisfy a condition of phase matching with the mode of the light propagating in the optical waveguide layer. The refractive index of the substrate can be lower than an effective refractive index of the light propagation mode in the optical waveguide where the surface plasmon polariton defined for the sensing medium side of the metal is phase-matched, or lower than the refractive index of a substance adsorbed by the periodic metal structure. The refractive index of the substrate can be higher than an effective refractive index of the light propagation mode in the optical waveguide where the surface plasmon polariton defined for the sensing medium side of the metal is phase-matched, and the filling factor of the metal is not lower than 80%.

In the sensing apparatus, an environmental change around the periodic structure can be sensed by observation of a change of the spectrum profile caused by a quantum interference of the light propagating in the optical guide with the light of the Rayleigh mode by means of the photosensor.

The sensing apparatus can have a means for measuring a simultaneously change of reflectance at plural wavelengths of the irradiated light beam.

The refractive index of the optical waveguide layer can be controlled by ultraviolet ray irradiation or temperature adjustment.

The sensing apparatus of the present invention has a waveguide layer between a periodic metal structure and a substrate. Thereby a light beam (electromagnetic field mode, hereinafter referred to occasionally as a “waveguide mode”) transmitted through the waveguide layer, and electromagnetic field mode (Rayleigh mode) formed by the periodic metal structure are phase-matched to cause a quantum interference to enable formation of a Fano type of resonance profile. Therefore the profile of the resonance absorption spectrum can be made steeper and the absorbance can be increased by controlling the phase-matching conditions of the existing modes. Thereby, the sensing object substance at or near the surface is subjected to a stronger electric field to give a stronger response to improve the sensor sensitivity.

Further, in the sensing apparatus of the present invention, by controlling the refractive index of the substrate, the transmission band gap in the periodic fine metal structure can be shifted across a Rayleigh wavelength of the refractive index of the substrate side (the volume-average of the refractive indexes of the substrate and of the optical waveguide layer for the intensity distribution of the light propagating in the optical waveguide layer).

Therefore, in sensing of an objective substance adsorbed on the fine periodic metal structure, the adsorbed objective substance tends to improve the phase-matching conditions. That is, the sensor can be made more sensitive by the presence of an adsorbed substance (e.g., a film for prevention of non-specific adsorption).

In the sensing apparatus of the present invention, a waveguide structure is combined with the periodic metal structure with a controlled metal filling factor to achieve the effect of enclosing a radiation mode (compensating a leakage loss). Thereby, even without satisfying strictly the phase-matching conditions, the sensing sensitivity can be improved by increasing the intensity of the SPPs at the interface between the periodic metal structure and the sensing medium.

In the sensing apparatus of the present invention, a spatial overlap of the electromagnetic modes composed of coupling of the Rayleigh mode and the waveguide mode with the periodic metal structure can be controlled by the phase matching conditions. In the present invention, a high Q value of the resonance profile can be obtained by controlling the spatial overlap. In such a state, the spectrum shift caused by adsorption of a sensing objective substance of several nanometers can be made larger relatively to the spectrum width of the resonance profile. Therefore, the differential signals for the adsorption amount at different wavelengths give a Fano type profile around a certain film thickness, and the position of the peak depends on the observation wavelength. When an incident light beam composed of different wavelength components of the light is introduced, each of the wavelengths of the light is allowed to correspond to different sensing distance ranges by catching the differential signals of the reflectivities of the light of the wavelengths. This enables selection of the optimum wavelength for maximizing the SNR of the differential signals relative to an intended sensing distance range, enabling a higher functionality than that in conventional techniques.

Excessive steepness of the absorption profile gives another problem that a slight error in formation of the structure can cause variation of the absorption peak wavelength among the sensing elements. In the sensing apparatus of the present invention, the wavelengths can be made equal by adjusting the refractive index of the waveguide layer when the absorption peak wavelengths should be equal for the incident light wavelength by control of the refractive index by ultraviolet irradiation or adjustment of the temperature. Therefore, the optimum response wavelength of the sensor can be adjusted independently of the illuminating system.

Further the quantum interference depends on coupling of the mode in optical waveguide layer with the mode of the periodic metal structure. The degree of the coupling in the quantum interference can be controlled to be optimum for the sensor by providing a construction of refractive-index/periodical-structure in the optical waveguide layer of the sensing apparatus of the present invention as necessary.

Further features of the present invention will become apparent from the following description of exemplary embodiments with reference to the attached drawings.

### BRIEF DESCRIPTION OF THE DRAWINGS

FIG. 1A illustrates an element constituted of a metal nanowire/slit array, a waveguide layer, and a substrate. FIG. 1B illustrates a sensing system for the element.

FIGS. 2A and 2B are graphs showing transmittances and reflectivity characteristics of the periodic metal structure of Λ=500 nm, d/Λ=0.2, and d_{g}=20 nm without and with a waveguide layer.

FIG. 3A shows reflection spectra of a periodic metal structure of Λ=450 nm, d/Λ=0.9, and d_{g}=150 nm without and with a waveguide layer (180 nm). FIG. 3B shows dependence of signal change on the thickness of a thin film of n=1.57 deposited on the structure.

FIGS. 4A, 4B, and 4C are graphs showing sensing in oblique light introduction: relation of resonance wavelength, and difference signals at 1195.38 nm and 1195.79 nm.

FIGS. 5A and 5B show response of the refractive index at Λ=500 nm, d/Λ=0.2, d_{g}=20 nm, and the incident angle of 45°.

FIG. 6 shows shift of the peak wavelength depending on the change of the refractive index of the waveguide layer.

FIGS. 7A, 7B, 7C and 7D illustrate a non-uniform waveguide structure.

FIG. 8 is a graph showing dispersion curves at the Au interface.

FIG. 9 is a graph showing dependence of a refractive index of a waveguide mode (solid line: basic mode, chain line: secondary mode).

FIG. 10 is a graph showing dependence of the transmission spectrum on the waveguide layer thickness.

FIG. 11 is a graph showing transmission spectra at a waveguide film thickness of 140 nm.

FIG. 12 is a graph showing dependence of the difference on the parameter (waveguide thickness and periodic metal structure layer thickness) with or without the film of the refractive index of 1.56, and the film thickness of 10 nm.

FIG. 13 is a graph showing dependence of thickness of the dielectric film (n=1.56) on the structure of the waveguide layer thickness of 150 nm and the metal layer thickness of 15 nm.

### BEST MODE FOR CARRYING OUT THE INVENTION

The sensing apparatus of the present invention comprises a sensing element having a metal member having a periodic structure formed on a substrate, a light source for projecting a light beam to the sensing element, and a photosensor for sensing the light beam through the sensing element.

The sensing apparatus of the present invention is characterized in that the sensing element has an optical waveguide layer between the substrate and the metal member and that the phase of the light beam projected from the light source and propagating in the optical waveguide layer is matched with the phase of Rayleigh-mode light formed by the metal member.

In the present invention, the sensing element includes those having a single-mode optical waveguide layer.

In the present invention, the term “single mode” signifies a state having only one electromagnetic fields distribution (including a degenerated distribution) for one wavelength of light.

The sensing apparatus of the present invention includes those having a light source which projects a light beam from under the substrate constituting the sensing element.

The sensing element of the sensing apparatus of the present invention may have a periodic metal structure on the substrate, and may function to sense an environmental change around the periodic metal structure.

The environmental change herein includes changes caused on the periodic metal structure or in the periphery thereof and can be sensed, including adsorption of a substance.

Therefore, for example, an antigen (sensing objective substance) can be sensed by an antibody immobilized on the periodic metal structure by adsorption.

In the present invention, the “periodic metal structure” denotes a one- or two-dimensional structure of a metal arranged at a repeating period shorter than the wavelength of the illuminated light beam from the light source.

The periodic metal structure can be constituted, for example, of a grating having a periodic indent pattern; a metal film having periodically arranged slits or holes; or wires, dots, or a fine metal member having a prescribed shape periodically arranged on a waveguide layer. The metal member should be placed periodically for a higher sensitivity. Further, in the present invention, for causing the quantum interference effectively, a part of the light propagating through the optical wavelength layer is preferably allowed to leak out to the periodic metal structure side (complete interception of the leakage of the light is not preferred).

From this viewpoint, a binary grating (grating having a binary profile) arranged periodically on the optical waveguide layer is preferred. The periodic pitch of the metal structure is preferably designed to be not larger than the wavelength of the introduced light.

In the sensing element of the apparatus of the present invention, a single-mode optical waveguide may be provided between the substrate and the periodic metal structure. The periodic metal structure may be fixed by an adhesive layer onto the optical waveguide layer.

The periodic metal structure is preferably constituted so that the primary diffracted wave of the incident light (projected light) may satisfy conditions for the phase-matching with the mode of the optical waveguide. The surface plasmon polariton induced by the periodic metal structure at the interface between the substrate and the metal or between the metal and the sensing medium satisfies preferably the phase-matching conditions with the optical waveguide mode (the light propagating in the optical waveguide layer). More preferably, the surface plasmon polariton, the Rayleigh mode in the fine periodic metal structure, and the optical waveguide mode satisfy simultaneously the phase-matching conditions.

The sensing apparatus of the present invention is preferably utilized for sensing an environmental change around the periodic metal structure by observing, with a photosensor, a change of the spectrum profile caused by of quantum interference.

The refractive index of the substrate is preferably lower than the effective refractive index of the light propagation mode in the waveguide matching with the surface plasmon polariton on the interface of the metal facing to the sensing medium side, or lower than the refractive index of a substance adsorbed by the periodic metal structure.

In the case where the refractive index of the substrate is larger than the effective refractive index of the light propagation mode in the waveguide matching with the surface plasmon polariton on the interface of the metal facing to the sensing medium side, the filling factor of the metal constituting the periodic metal structure is preferably not less than 80%.

The apparatus of the present invention may comprise a means for measuring simultaneously changes of reflectivity at plural wavelengths of irradiated light (wavelength of the incident light). The refractive index of the optical waveguide layer can be adjusted by ultraviolet ray irradiation or temperature control. The optical waveguide layer may have periodic change in the structure or the refractive index distribution.

The response of the plasmon sensor is observed as a change of the profile for the wavelength or the angle. For example, a reflectivity change ΔR for a perturbation quantity Δs at a wavelength λ is represented by Equation (1) below:

$$Δ R = \frac{\partial R}{\partial λ} \frac{\partial λ}{\partial s} Δ s \qquad ( 1 )$$

where the factor (∂R/∂λ) denotes a gradient (steepness) of the profile, and

the factor (∂λ/∂s) denotes the quantity of the shift for the perturbation. For observation of the shift by use of a white light source or a wavelength-scanning light source only, (∂λ/∂s) only be notified. However, in use of a monochromatic light like a laser beam as the light source, generally the sensitivity depends on the product of the above two factors. The present invention intends to improve the sensitivity of the sensor mainly by increasing the gradient of the profile of the former.

In the description below, the phase-matching conditions are considered by taking a one-dimensional periodic metal structure as an example. Although a one-dimensional periodic metal structure is described here, the basic principle is the same in a two-dimensional one.

The light beam from the illuminating optical system as the light irradiation means, is introduced as a TM-polarized light beam from the substrate side. The primary diffraction wave depends on Equation (2) below as a function of the period Λ of the periodic metal structure.

$${k}_{R} = \frac{2 π}{λ} {n}_{i} ( λ ) sin {ϕ}_{out} = \frac{2 π}{λ} {n}_{in} ( λ ) sin {ϕ}_{in} + \frac{2 π m}{Λ} \qquad ( 2 )$$

where n denotes the refractive index of the medium adjacent to the grating structure, and φᵢₙ and φₒᵤₜ denote respectively the incident angle or the output angle: the subscript “in” denotes an incident side (in =1), and the term “i” corresponds to the medium on the side of the output of an m-order diffracted light (i=1,2). Generally, the wavelength corresponding to φₒᵤₜ=π/2 is called a Rayleigh wavelength. The wave propagating in the periodic structure is called a Rayleigh mode (Rayleigh mode light). On the other hand, the wave number kₛₚ of the propagation type of surface plasmon is represented by Equation (3) below:

$${k}_{sp} = \frac{2 π}{λ} \sqrt{\frac{{ɛ}_{i} ( λ ) {ɛ}_{m} ( λ )}{{ɛ}_{i} ( λ ) + {ɛ}_{m} ( λ )}} \qquad ( 3 )$$

where ∈ₘ denotes the dielectric constant of the metal, and ∈ᵢ denotes the dielectric constant of the medium constituting the interface where the SPPs is excited (∈ᵢ=nᵢ²). Therefore, at the wavelength where the right side of Equation (2) is equal to Equation (3), the illuminating light is scattered by the periodic metal structure, and the phase of the incident light and the phase of propagation type SPPs are matched. As described above, there are four modes depending on the refractive indexes of the substrate and the sensing medium interface for the Rayleigh mode and the SPPs.

In particular, at direct light introduction (φᵢₙ=0), the Rayleigh wavelength is:

λ=nᵢ(λ)Λ (4)

Thereby, the wavelengths of the Rayleigh modes propagating in the positive direction and the negative direction becomes equal to each other to form a stationary wave. In this state, the stationary wave of the SPPs in the direction of the periodic structure vector is formed under the condition given by Equation (5):

$$\sqrt{\frac{{ɛ}_{i} ( λ ) {ɛ}_{m} ( λ )}{{ɛ}_{i} ( λ ) + {ɛ}_{m} ( λ )}} - \frac{m λ}{2 Λ} = 0 \qquad ( 5 )$$

where m=2q (q is an integer).

Next, the phase matching conditions are considered for a sensing element which has an optical waveguide (hereinafter simply referred to as a “waveguide”) introduced therein. The consideration is made perturbationally, assuming that the waveguide layer is thin enough, without limiting the present invention in any way.

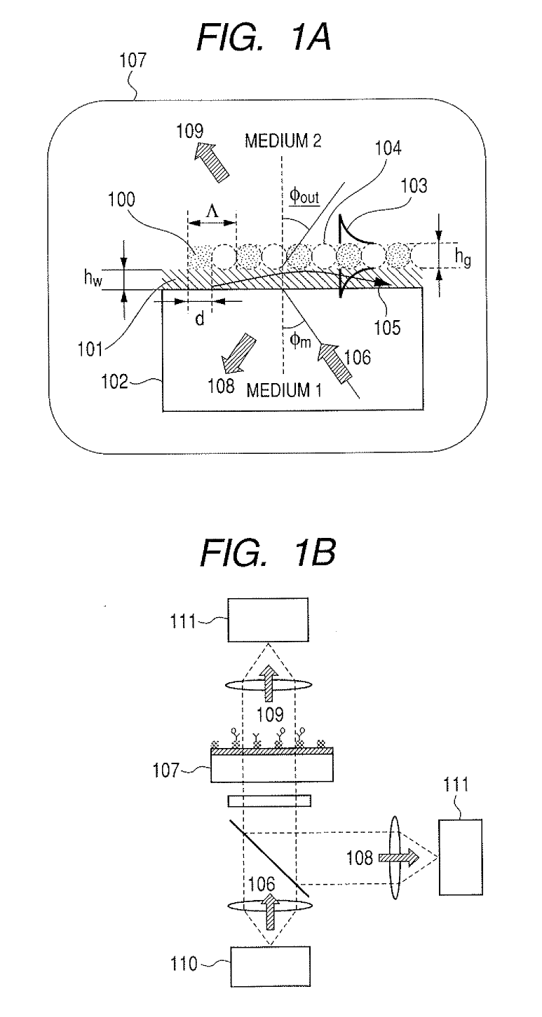

FIG. 1A illustrates an example of the sensing element 107 which comprises a one-dimensional periodic metal structure adjacent to a medium (medium 2), a single-mode waveguide layer, and a substrate.

The periodic structure is characterized by factors: the repeating period Λ, the breadth d of ridges 100, the height h_{g} of ridge 100. The thickness of waveguide layer 101 is denoted by h_{w}.

Incident light 106 is illuminated from a light source 110 (FIG. 1B) onto substrate 102 (medium 1) at an incident angle of φᵢₙ and is scattered by the periodic fine metal structure to induce the modes of SPP 103, Rayleigh mode 104, and waveguide mode 105. Reflected light 108 or transmitted light 109 from illuminating light 106 is sensed by sensor 111 (FIG. 1B). For a satisfactory SNR, the reflected light is preferably observed when the metal filling factor is large, or the transmitted light is preferably observed when the metal filling factor is small.

In the construction of sensing element 107 illustrated in FIG. 1A, the mode transmitted through the waveguide is defined by the effective refractive index n_{eff}. This effective refractive index can be varied largely by structural dispersion of the waveguide relative to the wavelength and the layer thickness.

This effective refractive index n_{eff} is related with the propagation constant β of the waveguide mode: n_{eff}=β/k₀=βλ/2π (λ: wavelength). Therefore when the wave number k_{R} defined for the interface i by Equation (2) is equal to the propagation constant β of the waveguide mode, strong coupling is formed between the SPPs and the waveguide mode to increase the absorption caused by the SPPS. However, the Rayleigh mode need not satisfy strictly the relation of φₒᵤₜ=π/2, since the waveguide layer makes the refractive index of the interface to be the volume average corresponding to the electromagnetic field distribution of the Rayleigh mode.

The above coupling state is made between the inherent mode and the continuous mode (waveguide mode). In observation, it cannot be distinguished from which state the photons are derived. Therefore, in the reflection spectrum and the transmittance spectrum, a quantum interference profile is formed depending on the coupling degree. Thus the gradient (steepness) of the reflectivity/transmittance profile (Equation (1)) can be increased by the increase of the absorption by the coupling and formation of the asymmetric profile by the quantum interference.

According to the above Equations (2) and (3), in the absence of the waveguide layer, the phase matching with the Rayleigh mode and with the SPPs can be achieved simultaneously in some wavelength by selecting suitably Λ and φᵢₙ. Since the combination is limited, and the transmission loss of the Rayleigh mode is large, steep spectrum profile cannot readily be obtained. However, in the presence of the waveguide structure, the Rayleigh mode is coupled with the waveguide mode to decrease the transmission loss and to give steepness of the spectrum profile. Further the phase matching conditions can be adjusted for the Λ by adjusting, for example, the waveguide layer thickness h_{w} advantageously.

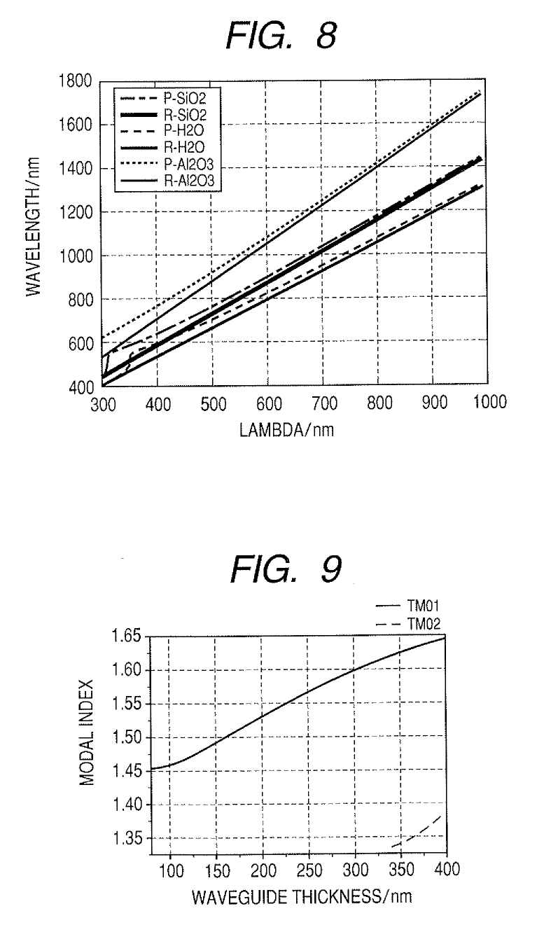

FIG. 8 is a graph showing dispersion relations between the Rayleigh mode (R) and the plasmon mode (P) at various material interfaces with Au as the metal according to Equations (2) and (3). The abscissa indicates the pitch Λ of the periodic metal structure, and the ordinate indicates the wavelength. In the graph, in the long wavelength side, R and P comes close together to facilitate the phase matching on the same interface. At the pitch Λ of 500 nm or less, the dispersion curve of the P is distorted to come to cross with the dispersion curve of R caused on another interface. For example, the plasmon mode at the interface of H₂O (water) can be phase-matched with the Rayleigh mode defined by the interface of SiO₂ (glass) at the pitch of about 430 nm. With a waveguide added, since the refractive index of the waveguide is high than that of the substrate, the pitch Λ for the phase matching is larger than the above size.

For example, in the element employing Au as the metal and SiO₂ as the substrate with the fine periodic metal structure of Λ=500 nm, the wavelength for satisfying Equation (5) at the substrate-metal interface is 762.5 nm. In this element, Equation (2) is satisfied at the refractive index nᵢ of 1.525. For the presence of the waveguide mode of n_{eff}=1.525, the refractive index n_{w} of the waveguide layer should be under the condition of n_{w}>n_{eff}. With such a material, the layer thickness h_{w} of the waveguide layer is decided according to the characteristic equation for the plane waveguide mode (K. Okamoto: Optical Waveguide Theory, Springer (2003)).

FIG. 9 shows, as an example, dependence of the mode refractive index on the layer thickness of Al₂O₃ as the waveguide material (wavelength being fixed to 762.5 nm). From FIG. 9, n_{eff}=1.525 at the layer thickness h_{w} of about 190 nm. (Actually, this is overestimate since the presence of the metal encloses more the mode in the waveguide layer to increase the mode refractive index.) Further, the larger layer thickness enables phase matching of the higher order of mode, but the wavelength for the phase matching is different among the modes. This is suitable for multiple wavelength sensing since the quantum interference profiles can be obtained at plural wavelengths.

The sensitivity of the sensor depends on the spatial overlapping of the modes, the gradient of the dispersion curve, and so forth. Generally, the sensitivity can be increased by decreasing the layer thickness and increasing the spatial overlap of the waveguide mode with the metal structure. Therefore a single-mode operation is desirable for the waveguide.

As described above, the phase-matching between the modes at the interface can be attained by adjusting the pitch and the waveguide thickness. In view of the necessity in the single-mode operation, the pitch is adjusted preferably within 30% of the value estimated without the waveguide. In the above example, in the graph showing the relation of the wavelength of the light with the pitch of the periodic metal structure, this pitch is 1.0-1.3 times the pitch at the intersecting point of the lines: the line for the surface plasmon polariton (P) at the interface at the side of the sensing medium (e.g., water) in contact with the periodic metal structure, and the other line for the Rayleigh mode (R) at the interface at the side of the substrate (e.g., SiO₂ (glass)) of the periodic metal structure. In other words, this pitch is in the range of 1.0-1.3 times the pitch of the wavelength of the phase-matching between the Rayleigh mode at the substrate side of the interface and the surface plasmon polariton at the medium side of the interface. In typical configurations, the accuracy in periodicity has emperically turned out to be within ˜30% (from 1.0× to 1.3× the predicted value). Specifically, in the above example, the pitch is preferably in the range from 430 nm to 560 nm. The waveguide layer thickness is preferably designed to obtain the mode refractive index in the range of 3% of the estimated value. According to such a design guideline, the quantum interference profile can be formed near the intended wavelength.

The above numerical estimation is an example of first-order approximation. For more precise discussion, the analysis should be made based on the coupling mode theory.

A calculation result based on a Fourier mode development is shown below (M. G. Moharam et al.: J. Opt. Soc. Am. A Vol. 12, p. 1069 (1995))

### EXAMPLES

### Example 1

### Phase-Matching to Stationary Wave SPPs on Substrate Side

In this Example, in the structure of the sensing element shown in FIGS. 1A and 1B. Substrate 102 is made of SiO₂, the sensing medium is water. In periodic fine metal structure 100, Λ=500 nm, d/Λ=0.2, and h_{g}=20 nm.

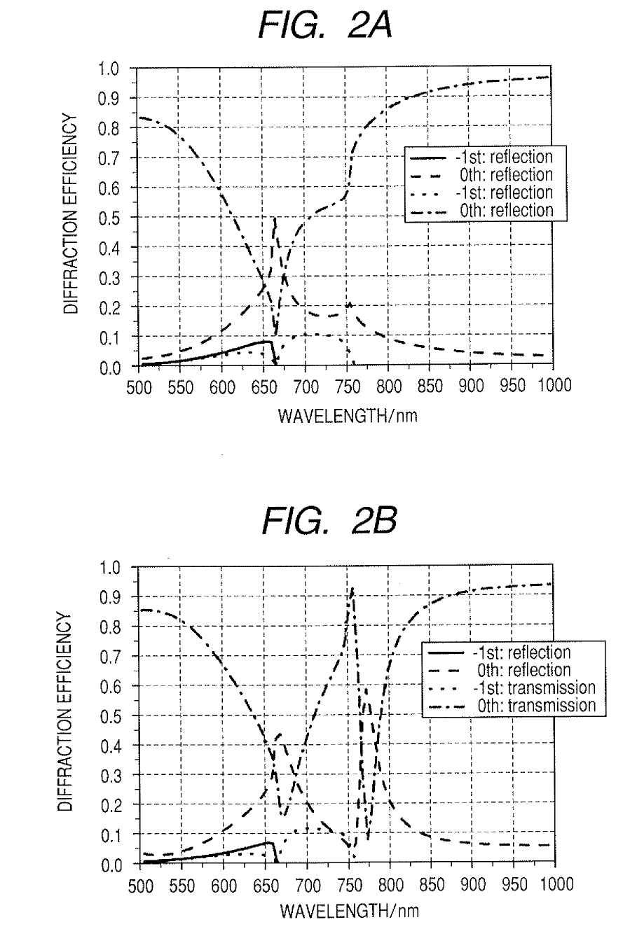

FIGS. 2A and 2B show diffraction efficiencies of the transmitted light beam directly introduced respectively in the absence of and in the presence of waveguide layer 101. In FIGS. 2A and 2B, the abscissa indicates the wavelength, and the ordinate indicates the diffraction efficiency.

Comparison of FIG. 2A with FIG. 2B shows that the introduction of the waveguide layer gives an asymmetric peak owing to the quantum interference at about 760 nm.

Since the effective refractive index n_{eff} of the waveguide depends on the refractive index and layer thickness of the waveguide layer, the Rayleigh wavelength for the given pitch should be larger than the cutoff wavelength for obtaining a sufficient effect of the quantum interference.

In this Example, the waveguide layer is formed from ITO (n: ca. 1.7), and the waveguide layer thickness for sufficient quantum interference is about 150 nm.

The added the waveguide layer increases the effective refractive index of the substrate, which causes slight shift of the resonance wavelength to the longer wavelength side in comparison with that without the waveguide layer. The waveguide layer increases the gradient of the resonance profile, namely ∂λ/∂s in Equation (1), by a multiplying factor of about 4.3 in comparison with that without the waveguide layer. Therefore, ΔR in Equation (1), one of the index of the sensor sensitivity, is increased on the assumption that ∂λ/∂s depends largely on the spatial localization degree of the SPP at this wavelength (no remarkable change by addition of the waveguide). Thereby, the sensitivity as the sensing apparatus is increased.

According to FIGS. 2A and 2B, even without the waveguide layer, the absorption at the water side is remarkable at the Rayleigh wavelength. This is caused by sufficient spatial overlap of this Rayleigh-mode stationary wave with the SPPs at the interface between the water and the periodic fine metal structure. This improvement of the spatial overlap results from improvement of spatial overlap of the Rayleigh-mode stationary wave at the short wavelength side with the metal rather than the spatial overlap of the Rayleigh-mode stationary wave at the long wavelength side with the metal owing to emergence of the loop portion of the electromagnetic field distribution in the periodic fine metal structure.

This absorption peak is effective as the sensing object. The two modes are in an energy eigenstate, and the coupling with a continuous mode is negligibly small. Therefore the profile is kept substantially in a Lorentz type, and the effect of increase of ∂R/∂λ cannot be obtained.

### Example 2

### Phase-Matching with Stationary Wave SPPs at Sensing Medium Side

This Example describes phase matching with the SPPs at the interface between water and a periodical fine metal structure. In the aforementioned Equations (4) and (5), the effective refractive index of the waveguide mode necessary for phase-matching with the stationary wave SPPs at the interface between the water and the periodical fine metal structure is n_{eff}=ca. 1.4. Therefore the substrate is selected which has the refractive index of not higher than 1.4. The substrate material is exemplified by LiF, and fluorine type polymers. On the other hand, the material for the waveguide layer may be SiO₂ which causes less loss for narrowing the resonance band.

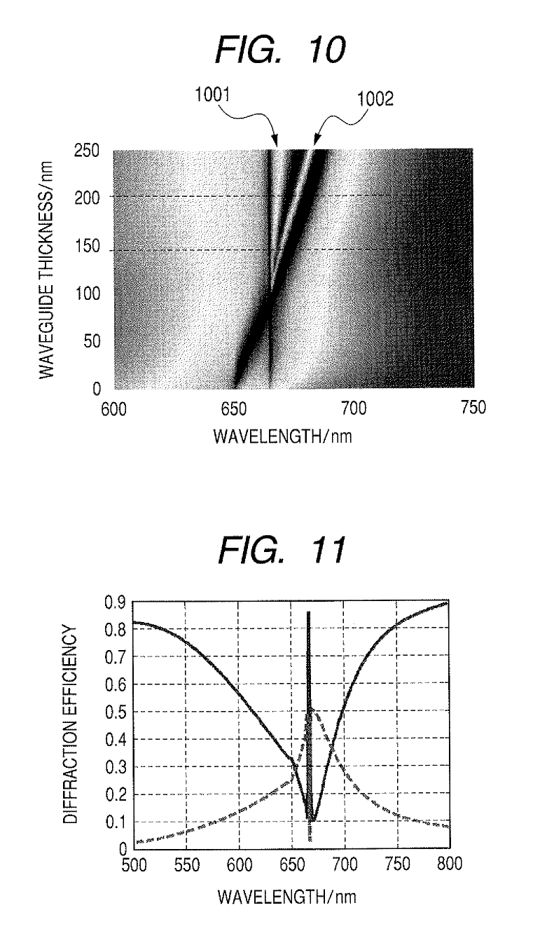

In this Example, the substrate is made of cytop (Asahi Glass Co.), a fluoropolymer: the waveguide layer is formed from SiO₂. The periodic metal structure has a pitch of Λ=500 nm, and d/Λ=0.2. FIG. 10 shows dependence of the transmittance spectrum on the waveguide thickness. In FIG. 10, the abscissa represents the wavelength. In this Example, owing to small difference between the refractive index at the substrate side and the refractive index at the water side, the peaks of the coupling of the plasmon and Rayleigh mode at the respective interface come close, and peak 1002 at the substrate side intersects the peak 1001 at the water side (layer thickness: ca. 120 nm). For sufficient amplitude modulation, the layer thickness is preferably made larger than that at this intersection point by several tens of nanometers. FIG. 11 shows, as an example, a transmittance spectrum at the layer thickness of about 140 nm. In FIG. 11, the solid line indicates the intensity transmittance, and the broken line indicates the intensity reflectivity. Thereby, a steep profile of quantum interference like EIT (electromagnetically induced transparency) is obtained.

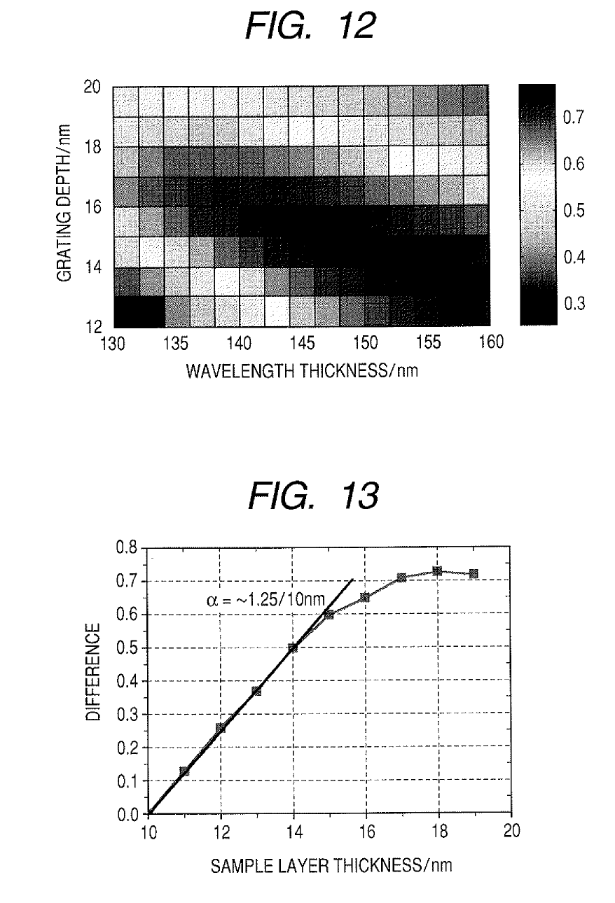

It has already been described that the sensitivity of the sensor cannot be evaluated only from the spectrum profile. In this Example, a spectrum change is calculated which is caused by an imaginary dielectric film having a refractive index of 1.56 and a thickness of 10 nm placed on the water side of the interface, and the dependency is investigated of the sensitivity on the structure parameters (the waveguide layer thickness, and the periodic metal structure thickness). FIG. 12 shows the calculated dependency. In FIG. 12, the portion at the right side denotes the difference by the color tone: the sensitivity is lower at the side of the index 0.3, and the sensitivity is higher at the side of the index 0.7. The sensitivity is higher with the smaller layer thickness owing to the smaller loss in the system. However, the sensor performance becomes saturated at the layer thickness of 15 nm or smaller. The optimum thickness of the waveguide layer depends on the layer thickness of the periodic metal structure. According to FIG. 12, a thickness of about 150 nm of the waveguide layer and a thickness of about 14 nm of the periodic metal structure are selected as an optimal combination. FIG. 13 shows the dependency of the layer thickness of the dielectric layer of n=1.56. From the gradient, the dependency is about 0.125/nm, suggesting the change by 12.5% of the signal value for the layer thickness change of 1 nm. This sensitivity is higher by one decimal digit than an ordinary plasmon sensor.

In comparison with Example 1, the sensor sensitivity is improved by phase-matching employing SPPs at the interface between water and the periodic fine metal structure as in this Example. This improvement is due to a larger spatial overlap of the SPPs with the sensing objective substance, and to the increase of the gradient of the resonance spectrum by the quantum interference.

### Example 3

### Sensor Sensitive to Surface: by Direct Light Introduction

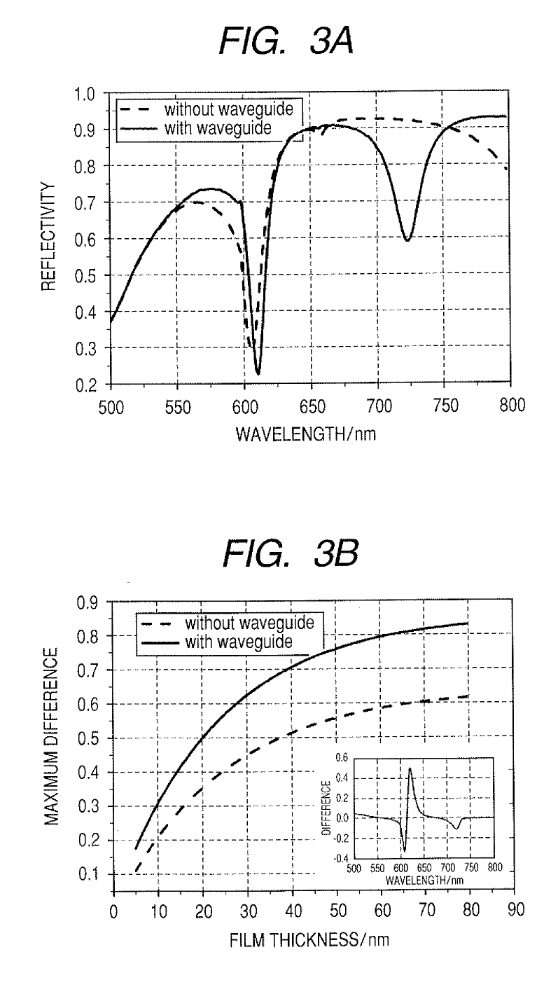

In this Example, sensing by utilizing SPPs at the interface between water and a periodic fine metal structure is considered with a SiO₂ substrate (n: ca. 1.458). FIG. 3A shows spectra of reflected light with sensing element 107 having a structure with an increased filling factor (A=450 nm, d/A=0.9, and H_{g}=150 nm) and a waveguide layer made of Al₂O₃ (n: ca. 1.76) and having h_{w} of 0/180 nm. The presence of the waveguide layer intensifies the absorption at the Rayleigh wavelength (λ: ca. 610 nm) on the water side. This is due to strengthening of the coupling with the stationary wave SPPs resulting from reflection by the periodic fine metal structure having a large filling factor since the Rayleigh mode at the water side can be regarded as an irradiation mode of the waveguide, although it is not coupled with the waveguide under the conditions in this Example. The occurrence of the asymmetry by the quantum interference is slight in comparison with that in Example 1, but the sensor sensitivity is improved. This is described below. Incidentally In FIG. 3A, the abscissa indicates the wavelength, and the ordinate indicates the reflectivity.

For investigation on the response of the sensor, a dielectric film of n=1.57 is deposited at and near the surface as simulation of adsorption of a sensing objective substance.

FIG. 3B shows plots of the maximum differences of the reflection coefficient from that at the film thickness of zero nanometer in the presence of and in the absence of the waveguide layer (corresponding to Equation (1)). With increase of the dielectric film thickness, the difference increases. However, the signal change comes to be saturated at about 50 nm of the thickness either in the presence of or absence of the waveguide layer. The presence of the waveguide layer increases the maximum difference by about 30%, indicating the increase of the signal change according to Equation (1).

The presence of the waveguide layer improves the sensor sensitivity by keeping the sensing distance from the surface unchanged, or keeping the surface sensitivity.

As described above, in adsorption-sensing by utilizing the stationary SPPs at the interface between the water and the periodical fine metal structure, the adsorption of the deposition film causes a shift to the longer wavelength side to facilitate the phase matching with the waveguide mode. Therefore, the refractive index of the substrate is preferably lower than that of the adsorption film.

### Example 4

### Sensor Sensitive to Surface: by Oblique Light Introduction

Sensing is conducted by oblique light introduction (φᵢₙ is not zero in FIG. 1A). In this case, both the Rayleigh mode and the SPPs are of a transmission type.

With increase of the incident angle, generally at the wavelength longer than the Rayleigh wavelength, the wave numbers of the Rayleigh mode and the SPPs represented by Equations (2) and (3) come close together, and the phase-matching is easier even without the waveguide. However, the waveguide enables the phase-matching at an arbitrary incident angle.

The spatial overlap of the propagation type of SPPs with the metal can be made smaller by decreasing sufficiently the thickness of the periodic fine metal structure, and the loss is not caused. Thereby the Q value of the resonance can be made larger.

In this Example, sensing element 107 has a structure of Λ=500 nm, d/Λ=0.2, and h_{g}=20 nm, and a waveguide of Al₂O₃ with h_{w}=180 nm. Thereto illumination light 106 is projected at an angle φᵢₙ=45°.

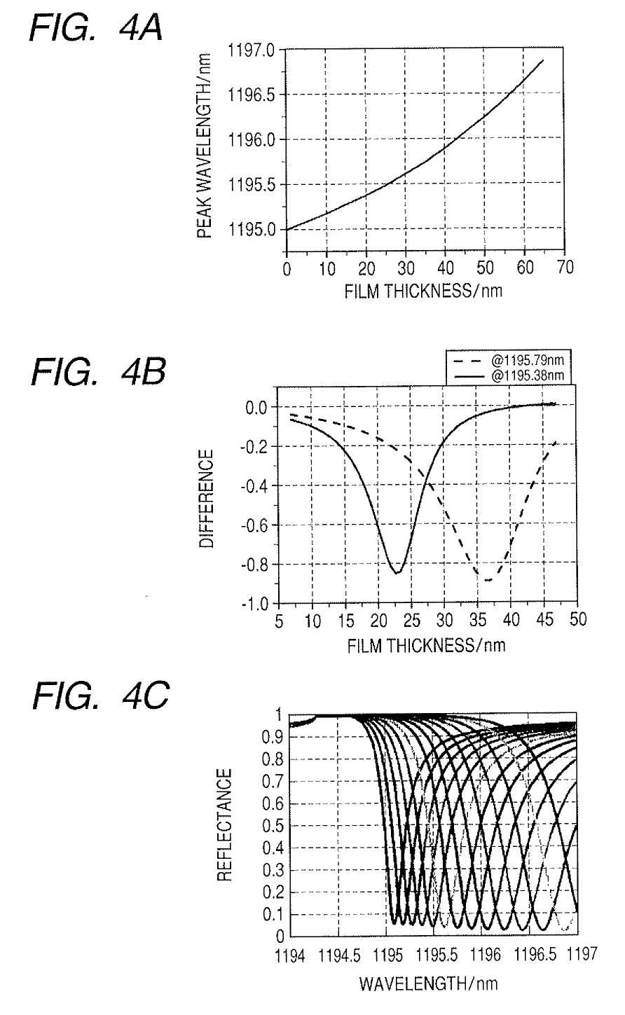

As in Example 3, a dielectric film (n=1.57) is deposited to simulate adsorption of a sensing objective substance. FIG. 4A shows the relation of the film thickness with the resonance peak wavelength.

As shown in FIG. 4C, the resonance breadth is about 0.1 nm, whereas, in FIG. 4A, deposition in a thickness of 20 nm causes a shift of about 0.35 nm of the peak wavelength. Therefore the difference of the reflectivity from that at the film thickness of zero nanometer becomes saturated readily. However, by observation of the difference from the reflectivity at 0 nm with the wavelength with a certain offset (at about 0.4 nm and about 0.8 nm in this Example) from the original resonance wavelength (1195.0 nm), a Fano type profile having a breadth of about 10 nm is observed (FIG. 4B). Therefore, a deposited film formed on an existing film of a certain thickness can be detected with a high sensitivity by observing the difference at two or more fixed wavelengths. This is obvious from the maximized difference at that film thickness.

With increase of the film thickness, the adsorbed film comes to function like a part of the waveguide to increase the spatial penetration of the mode to the adsorbed film side. Thereby the spatial overlap with the metal increases to reduce the loss in propagation of the waveguide mode to lower the Q value of the resonance peak. This is directly reflected to the film thickness profile as shown in FIG. 4B. Now, as an example, a case is considered in which a dielectric-responsive substance is drifting at a distance of 100 nm apart from the interface. In this state, the penetration of the mode to the adsorbed film side is increased, resulting in broadening of the profile in FIG. 4B. This tendency is more remarkable at a larger offset. Therefore, the presence or absence of the drifting substance can be sensed by monitoring difference of the signal at plural wavelengths with limited offsets.

More specifically, as an embodiment of the example shown in FIG. 4B, outputs of laser beams having wavelengths of 1195.79 nm and 1195.38 nm are coupled by a fiber coupler, and are employed as a light source 110 in FIG. 1B, for example, for monitoring adsorption of a liquid layer.

Firstly, a buffer solution containing an adsorbable substance is allowed to flow on a metal surface in a flow path to cause adsorption of a certain amount of the substance, and then the buffer solution containing no adsorbable substance is allowed to flow there. For the measurement, a calibration curve is prepared separately for the ratio of difference signals at the two wavelengths as a reference.

Secondly, the buffer solution containing the adsorbable substance is allowed to flow there, and the difference signals at the wavelengths of 1195.38 nm and 1195.79 nm and the ratio thereof are measured.

A large difference of the latter from the reference value is regarded to be caused by the drifting substance. Therefore an error signal may be input or the measurement may be continued until the ratio is brought into the standard range approximate to that of the reference value.

A higher precision can be achieved by this technique by monitoring at more numbers of wavelengths by employing a light source like a DWDM source (dense wavelength division multiplexing light source).

The system described in this Example is substantially effective in the range in which the condition is satisfied that the shift is larger than the resonance breadth. Therefore, for function for detecting the presence of the drifting substance in a broader range (in the space and the refractive index), it is particularly important to decrease the loss in delivery (absorption, scattering) in the waveguide, since the loss in the waveguide will cause directly broadening of the resonance breadth.

### Example 5

### Refractive Index Sensor

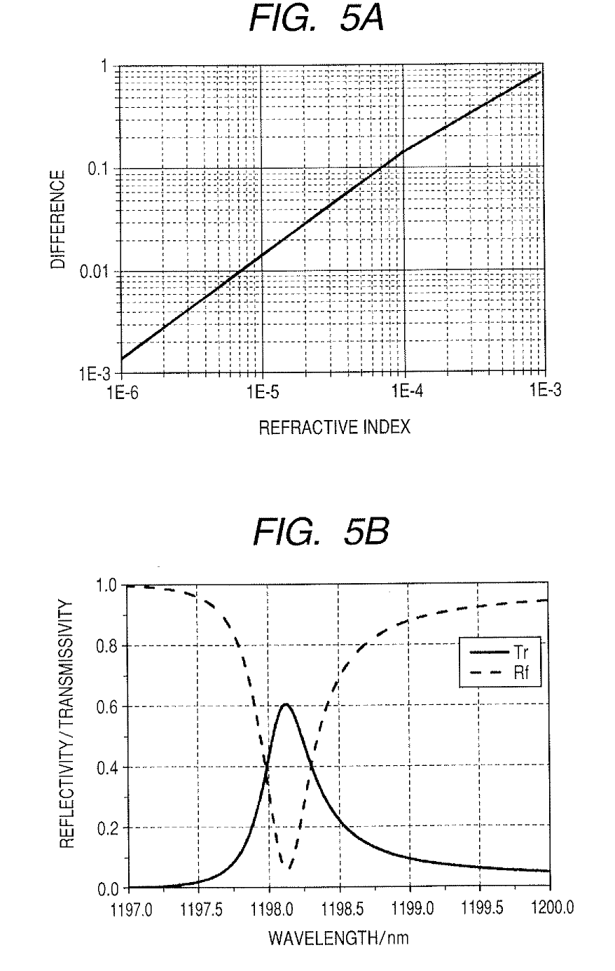

FIGS. 5A and 5B show refractive index response at the incident angle of 45°. In FIG. 5A, the abscissa indicates the refractive index and the ordinate indicates the difference. In FIG. 5B, the abscissa indicates the wavelength and the ordinate indicates the reflectivity/transmissivity.

In this Example, a narrow-band light source is employed, and the response to a slight refractivity change of water is obtained as the sensor response to a homogeneous medium used in Example 4. In this Example, the Q values of the profile is remarkably large, and for the refractive index change Δn of about 10⁻⁶, the reflective index changes by 0.1% or more.

### Example 6

### Control of Resonance Peak Wavelength

As shown in FIGS. 4A to 4C, the breadth of the resonance profile is in an order of about 0.1 nm. In laser measurement with such a system, although the profile breadth is larger than the beam breadth of the DFB laser, the light source is required to be wavelength-variable in consideration of the production error.

Therefore, the waveguide layer is formed from a photo-sensitive film such as Ge-containing SiO₂, and ITO and the refractive index is adjusted by irradiation of ultraviolet ray in a controlled irradiation intensity.

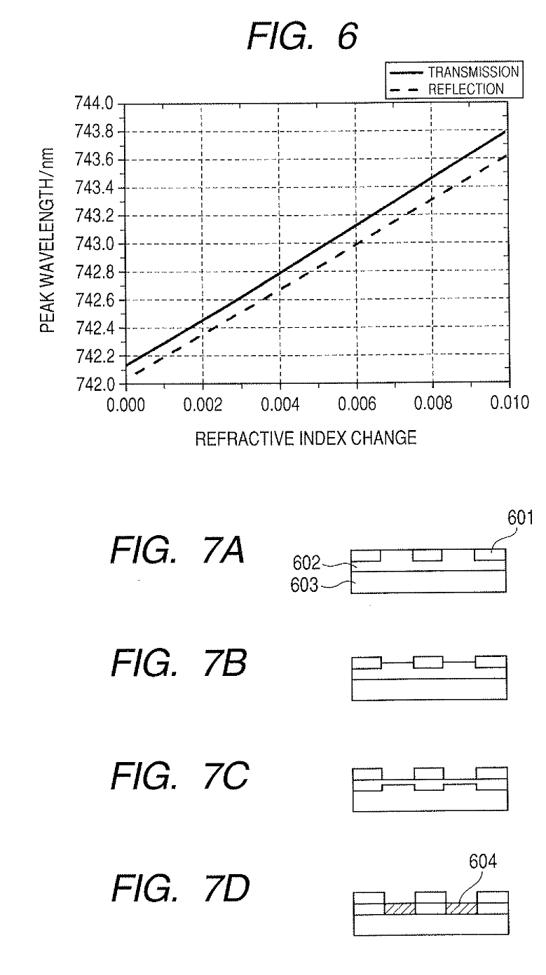

As shown in FIG. 6, a variation of the refractive index by an order of 10⁻³ can vary the resonance peak wavelength by about 0.1 nm. In another approach, an inorganic oxide material has a refractive index-temperature dependency of about 10⁻⁵/K, and enables wavelength variableness of about 0.1 nm by temperature control of about 100° C.

Generally the ultraviolet ray irradiation can change irreversibly the refractive index by an order of 10⁻³ or higher (S. Pissadakis et al.: Applied Physics A V61.69 (3), pp, 333-336 (1999); R. Kashyap: Fiber Bragg Gratings, Chapter 2, Academic Press, London (1999)). The approach with ultraviolet irradiation is useful for tuning of the wavelength in a broader wavelength range.

According to this Example, the wavelength of the sensing element can be varied for a wavelength-fixed light source having an athermalized structure. This is effective in cost reduction.

### Example 7

In this Example, a structural perturbation is caused in the waveguide layer, being different from the above Examples employing a uniform waveguide layer.

As illustrated in FIG. 7A, the groove portions of periodical fine metal structure 601 on substrate 603 are integrated with optical waveguide layer 602 to improve the spatial overlap of the Rayleigh mode with the optical waveguide and to strengthen the coupling between them.

FIG. 7B illustrates another example of the constitution in which the periodic fine metal structure is allowed to protrude from the waveguide layer. FIG. 7C illustrates still another example in which the thickness of the waveguide is made smaller periodically at the portions in contact with the metal structure. Thereby, the spatial trapping of the waveguide mode is decreased at the portions to improve the spatial overlap between the waveguide mode and the SPPs at the interface between the metal and the sensing medium to strengthen the coupling between them.

Further, the refractive index of the waveguide layer may be changed at portions 604 under the groove portions of the periodic fine metal structure by ultraviolet ray irradiation or a like method. Thereby, from the reason described above, the electric field of the SPPs can be intensified at the interface between the metal and the sensing medium to improve the sensor sensitivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-077892, filed Mar. 23, 2007, which is hereby incorporated by reference herein in its entirety.

1. A sensing apparatus comprising a sensing element having a metal member of a periodic structure formed on a substrate, a light source for illuminating a light beam to the sensing element, and a photosensor for sensing the light beam from the sensing element, wherein the sensing element has an optical waveguide layer between the substrate and the metal member, and the light beam illuminated from the light source and propagating in the optical waveguide layer and the light of a Rayleigh mode formed by the metal member are phase-matched.

2. The sensing apparatus according to claim 1, wherein the waveguide layer is in a singlemoded.

3. The sensing apparatus according to claim 1, wherein the light of the Rayleigh mode is a primary diffracted wave of the light illuminated from the light source.

4. The sensing apparatus according to claim 1, wherein the surface plasmon polariton induced by the periodic structure satisfies a condition of phase matching with the mode of the light propagating in the optical waveguide layer.

5. The sensing apparatus according to claim 4, wherein the refractive index of the substrate is lower than an effective refractive index of the light propagation mode in the optical waveguide where the surface plasmon polariton defined for the sensing medium side of the metal is phase-matched, or lower than the refractive index of a substance adsorbed by the periodic metal structure.

6. The sensing apparatus according to claim 4, wherein the refractive index of the substrate is higher than an effective refractive index of the light propagation mode in the optical waveguide where the surface plasmon polariton defined for the sensing medium side of the metal is phase-matched, and the filling factor of the metal is not lower than 80%.

7. The sensing apparatus according to claim 1, wherein an environmental change around the periodic structure is sensed by observation of a change of the spectrum profile caused by a quantum interference of the light propagating in the optical guide with the light of the Rayleigh mode by means of the photosensor.

8. The sensing apparatus according to claim 1, wherein the sensing apparatus has a means for measuring a simultaneously change of reflectance at plural wavelengths of the irradiated light beam.

9. The sensing apparatus according to claim 1, wherein the refractive index of the optical waveguide layer is controlled by ultraviolet ray irradiation or temperature adjustment.

10. The sensing apparatus according to claim 1, wherein the pitch of the periodic structure is in the range of 1.0-1.3 times the pitch of the wavelength of the phase-matching between the Rayleigh mode at the substrate side of the interface and the surface plasmon polariton at the medium side of the interface.
